(19) United States
(12) Patent Application Publication
(10) Pub. No.: US 2007/0083826 A1
(43) Pub. Date: Apr. 12, 2007

(54) Method and system for scaling the area displayed in a viewing window

(76) Inventors: John Ray Pessetto, Fort Collins, CO (US); Jason Harold Culler, Livermore, CO (US)

Correspondence Address: HEWLETT-PACKARD COMPANY;Intellectual Property Administration, P.O. Box 272400, Fort Collins, CO, 80527-2400, US

(21) Appl. No.: 11/374,296

(22) Filed: May 13, 2004

(51) Int. Cl. G06F 17/00

(52) U.S. Cl. 715/800; 716/1

(57) ABSTRACT

One exemplary method includes selecting an object feature, obtaining a scaling factor that is associated with the object feature, and adjusting the viewing area of the image displayed in accordance with the scaling factor.

### BACKGROUND

Computer Aided Design (CAD) tools are commonly used in the design of very large scale integrated (VLSI) circuits and other microchips and chip packages. A typical design or circuit includes a very large number of different objects, such as, for example, “and” gates, “nand” gates, “or” gates, and “nor” gates. Generally, the objects or blocks have one or more features (an “object” feature), or ports. These object features or ports are used to connect the objects to other objects to form integrated circuits. Connecting the object features is commonly referred to as routing. Routing is accomplished by placing metal or other suitable material between the object features or ports. The width of the routing is typically measured in microns, or fractions of microns. The CAD tool automatically generates the routing for a large portion of circuit. The remaining connections for the circuit are manually routed.

CAD tools typically contain logic for “zooming-in” and “zooming out” within the graphical circuit representation, or “circuit image.” “Zooming-in” and “zooming-out” adjusts the viewing area of a circuit image displayed on a viewing device, such as, for example, a monitor. Typical zooming functions include: “zoom window,” “zoom extents,” and “zoom out.” “Zoom window” allows a user to select a window of the circuit image upon which to zoom-in. To “zoom window” the user selects the zoom window command, picks a point on the circuit image and drags the pointer, creating a window upon release. The “zoom window” command adjusts the viewing area on the display to show the area of the circuit image selected by the zoom window input. “Zoom extents” zooms out to the outermost boundary of a circuit image. Typically, the user selects the zoom extents command and the CAD tool adjusts the viewing area on the display to show the entire image, or circuit. Finally, the “zoom out” command typically adjusts the viewing area on the display to show the previous viewing area display. All of these typical functions require a user to select a zoom function. Selecting a zoom function typically cancels the current command and performs the zoom function.

When beginning to manually route, it is preferable to be “zoomed out” so that the global features for a large area of the circuit are displayed. At a minimum, it is preferable to view at least the objects that are being connected on the monitor. At this zoom level, the user can identify global circuit features and objects, but not necessarily object features or ports of the objects. One goal of CAD is to ensure the metal (or other routing material) is in contact with an object feature or other metal. A gap of 1/10 of a micron typically results in a defective circuit. To ensure that the metals and/or objects touch, a user must at least “zoom in” on the object feature or port which is a target of the connection. Zooming in magnifies the object feature or port. Since it is important to ensure that metal contacts metal, it often requires multiple zooms to obtain the desired view size of the circuit image including the object feature or port.

### SUMMARY

A system for automatically adjusting a display area of an image on a viewing window for a computer aided design tool is provided. The system includes auto-zoom logic for automatically adjusting a magnification level and display area of an image on a viewing device. Typically, the magnification level is a function of at least one pre-defined scaling factor.

In addition, a method for scaling a viewing area of an image for a computer aided design tool is provided. One method includes selecting an object feature, obtaining a scaling factor that is associated with the object feature, and adjusting the viewing area of the image displayed in accordance with the scaling factor.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example principles of the invention.

FIG. 1 is an exemplary diagram of an embodiment of a system for automatically adjusting the display area of graphical circuit representation in a viewing window.

FIG. 2 is an exemplary diagram of an embodiment for auto-zoom logic.

FIGS. 3A and 3B are exemplary illustrations of objects displayed in a viewing window in accordance with an embodiment of the present invention.

FIGS. 4A and 4B is an exemplary flowchart illustrating an exemplary methodology for automatically adjusting the viewing area of graphical circuit representation displayed in a viewing area in accordance with an embodiment of the present invention.

FIG. 5 is an exemplary flowchart illustrating an exemplary methodology for automatically adjusting the viewing area of graphical circuit representation displayed in a viewing area in accordance with an embodiment of the present invention.

### DETAILED DESCRIPTION

The following includes definitions of exemplary terms used throughout the disclosure. Both singular and plural forms of all terms fall within each meaning. Except where noted otherwise, capitalized and non-capitalized forms of all terms fall within each meaning:

“Graphical circuit representation” and “circuit image” are used interchangeably herein and indicate a graphical representation of a circuit or any part thereof as provided by any suitable CAD program.

“Scaling,” and “zooming” are used generically and interchangeably and indicate manipulation of the area displayed on a viewing device. For example, “zooming in” on an object or area magnifies the object or area displayed, and “zooming out” de-magnifies the object or area displayed.

“Object,” as used herein, is used generically and includes a component of a circuit, or a graphical representation of a component of a circuit.

As used herein, “object feature” is used generically and includes blocks, connection ports or similar feature(s) on an object.

“Logic” as used herein includes, but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Software”, as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

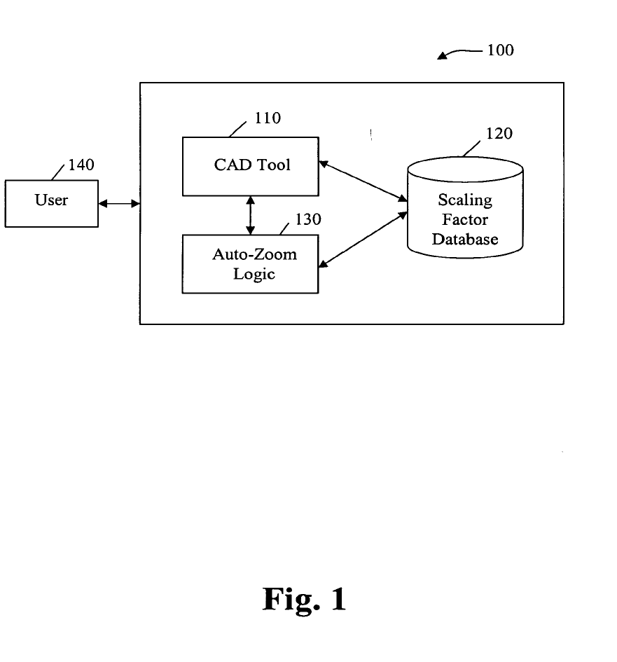

FIG. 1 illustrates an exemplary system 100 for automatically adjusting a display area of a circuit image on a viewing window for a computer aided design tool. The system 100 includes a Computer Aided Design (CAD) tool 110. The CAD tool 110 is any suitable CAD tool, such as, for example Allegro or Advanced Package Designer by Cadence Design Systems, Inc. of San Jose, Calif. The system 100 includes auto-zoom logic 130 and optionally scaling factor database 120. A user 140 interacts with the system 100 by any suitable method, such as for example, via a keyboard, mouse and/or computer monitor.

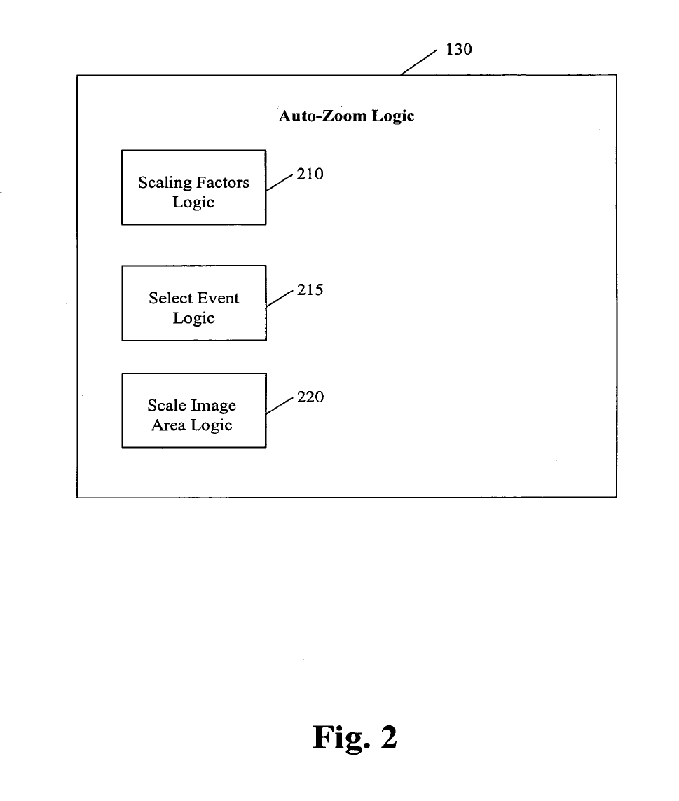

Autozoom logic 130 includes any suitable steps, processes and/or software for automatically scaling a circuit image area displayed on a viewing device based upon selection by a user of an object or an object feature. With reference to FIG. 2, the auto-zoom logic 130 includes one or more of scaling factors logic 210, select event logic 215 and scale circuit image area logic 220 or combinations thereof. Generally, the auto-zoom logic 130 allows a user to select a displayed object or object feature and the auto-zoom logic 130 automatically scales the circuit image area displayed on the viewing device or monitor.

Scaling factors logic 210 includes any suitable steps, including, processes and/or software for determining the amount of, or size of (e.g., what scaling or zooming factor to use, the circuit image that is displayed in a viewing area based upon an event, trigger or object (or object feature) selection. In an embodiment, one or more scaling factors are input into the system by a user 140 for, e.g., one of objects, object features or groups (or types) of objects or object features. Optionally, one or more scaling factors can selected from a list. Also optionally, one or more scaling factors can be retrieved from a scaling factors database 120, described in more detail below. Still further optionally, the scaling factors are preset or are automatically determined by monitoring personal usage preferences, such as “intelligent” logic which “learns” scaling factor(s) from a user's frequent scaling(s) of particular objects of object features. In an embodiment, a user sets the scaling factors 210 by selecting a command, such as a “set scaling factors” command in the CAD software, and associating a particular scaling factor with a particular object, object feature or group of objects and/or object features. One or more scaling factors can be set at this time. Different scaling factors can be selected based on different types of events, triggers or objects (or object features). Scaling factors include any means for adjusting the size or area of the circuit image displayed, such as multiplication factors (e.g., zoom in by 2×), percentages (e.g., always show this type of object feature as 50% of viewing area site), set sizes (e.g., always show this object at a scale of 5 microns to a pixel) etc.

Select event logic 215 includes any suitable steps, including, processes and/or software for identifying and/or inputting any action that triggers auto-zoom logic 130. Events include any suitable action preferred by a user, such as, for example, “selecting an object,” “selecting near an object” and “selecting an object feature.” As per scaling factors logic 210, a scaling factor is associated with each type of event. As noted above, various types of scaling factor may be used, such as, multiplication factors, percentage factors etc. For example, the scaling factor of 2× is associated with the “selecting an object event.” Similarly, a scale factor of 10× can be on “selecting an object feature event”, and a scaling factor of 5% can be associated with the “selecting near an object event.” These scaling factors are optionally stored or preset upon being determined by the scaling factors logic 210.

“Selecting” is achieved by any suitable method. For example, a user may select an object or an object feature currently displayed in a circuit image by “clicking” on it or otherwise selecting it (e.g., using tab and spacebar when only a keyboard is in use). In another example, selection occurs by a user entering an identification of an object, object group, object feature, etc. by an identifier recognized by the CAD tool. In still another example, selection occurs contemporaneously with the results of a “search” query for a particular object or object function.

In the context of the aforementioned examples, upon a user selecting an object, an associated scaling factor of 2× is obtained or returned. If the user selects an object feature or port, a scaling factor of 10× is obtained or returned, and if the user selects a point near an object, but not the object itself, a scaling factor of 5% is obtained or returned.

Scale circuit image area logic 220 includes any suitable steps, methods, processes and/or software for adjusting the area of the image displayed on the monitor based upon the returned scaling factor. The area of the circuit image displayed on the monitor is thus determined as, a function of the scaling factor obtained or returned by the scaling factor logic 210 and by the occurrence of an event, as identified by the select event logic 215. For example, with respect to the above examples, the first event is the “select object event” with an associated scaling factor of 2×. The scale circuit image area logic 220 automatically sets the size of the viewing area displayed on the monitor to 2 times the size of the object that was identified by the select object event 215 (i.e., the object takes up approximately 50% of the viewing area). Similarly, if the event is the “select object feature” and the associated scaling factor is 10 times the size of the object feature, then the scale image area logic 220 automatically sets the area displayed on the monitor to 10 times the size of the object feature or port. For example, if the object feature is 5 microns wide, the viewing area is automatically set to 10 times 5 microns, or 50 microns. In the final example, the event is “select near an object” and the associated scaling factor is 5%, if the user selects a point near an object but not the actual object then the area displayed on the monitor is adjusted to display 5% of the size of the current display. In one embodiment, the scaling factors obtained by the scaling factors logic 210 are stored in the scaling factors database 120, discussed in more detail below.

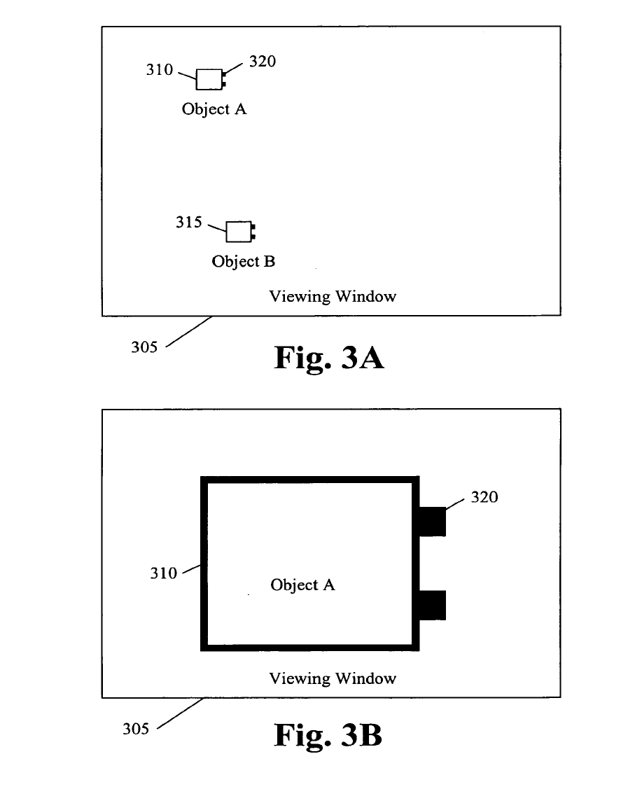

FIGS. 3A and 3B serve to exemplify the scale image area logic 220. In FIG. 3A the area of the circuit image displayed includes a viewing window 305 that displays 2 objects, Object A 310, and Object B 315. If the scaling factor of 10× is associated with the “select object feature event,” and a user 140 selects port or object feature 320 on Object A 310, the scale circuit image area logic 220 automatically adjusts the area displayed in the viewing window 305 so that the viewing window 305 is 10 times the size of the object feature or port 320 illustrated in FIG. 3B. It will be appreciated that certain objects and/or object features may not be visible at the zoom factor in FIG. 3A (due to, e.g. the small size of such an object or object features), but may be visible at the zoom factor in FIG. 3B.

The description above illustrates the scale circuit image area logic 220 zooming in on the image. A similar process works for zooming-out on the image. For example, assume the scaling factor associated with the “select object” event is 10× and the scaling factor associated with the “select object feature” is also 10×. As described above, if the user 140 selects object feature 320, the scale area circuit image logic automatically adjusts the area of the viewing window 305 to 10 times the selected object feature 320. If the user 140 selects the “object” event (i.e. selects Object A 310 in FIG. 3B), the scale circuit image area logic zooms-out of the circuit image and automatically adjusts the area of the viewing window 305 to 10 times the size of Object A. Similarly, the “select near an object” event functions to zoom out of the circuit image. In one example, if the “select near an object event” is associated with a scaling factor of 150%, and the “select near an object event” is selected, the scale area circuit image logic 220 automatically scales the area displayed to 150% of the size of the current window. Similarly, a scaling factor of 1.5 would result in 1.5 times the current area displayed.

The scaling factors are optionally adjustable based on the personal preference of the user 140. Optionally some or all of the events and/or scaling factors are pre-programmed and are not adjustable by the user. Alternatively, the number of, and types of, events and/or scaling factors are user selectable. The user can create his/her own events, such as, for example, hot keys that automatically zoom in on or out of certain areas. Alternatively, coordinates that correlate to objects, object features, or object ports, can be events, based upon coordinates input by the user, the scale area circuit image logic zooms in on or out of the circuit image and adjusts the area displayed on the viewing device. Still yet, alternatively, “select an area” event is provided and the scale area circuit image logic 220 automatically scales the area displayed to display the most likely or the closest feature to a selected point.

The system 100 optionally includes a scaling factor database 120. The scaling factor database 120 stores one or more event(s) and one or more scaling factor(s) associated therewith. In one embodiment, a number of events are pre-stored in the scaling factors database, and a user 140 associates scaling factors with each event. Alternatively, the events are created by the user 140 and are stored, along with the corresponding scaling factors, in the scaling factors database 120 (e.g., “intelligently” creating the database by empirical usage reports or tracking). In one embodiment, the scaling factors database includes a user profile field. The user profile field allows multiple users to store different scaling factors for the same event. Thus, user 1 can associate a scaling factor of 2× with event 1, and user 2, can associate a scaling factor of 3× with event 1. In this embodiment, the scale circuit image area logic 220 automatically adjusts the area of the circuit image as a function of the event, and the scaling factor that is associated with the particular user. The particular user is optionally automatically identified based on the user that is logged on to the terminal at that time. It will be appreciated that the scaling factors database 120 is any suitable database, and may be embodied in a single or multiple databases, and/or may be a part of any database which contains information relating to the CAD tool and/or the circuit image.

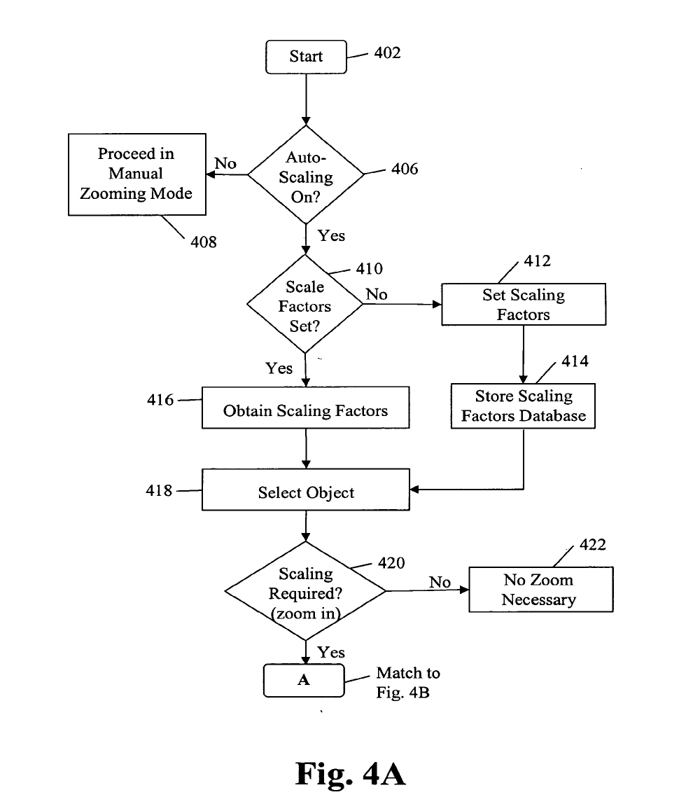

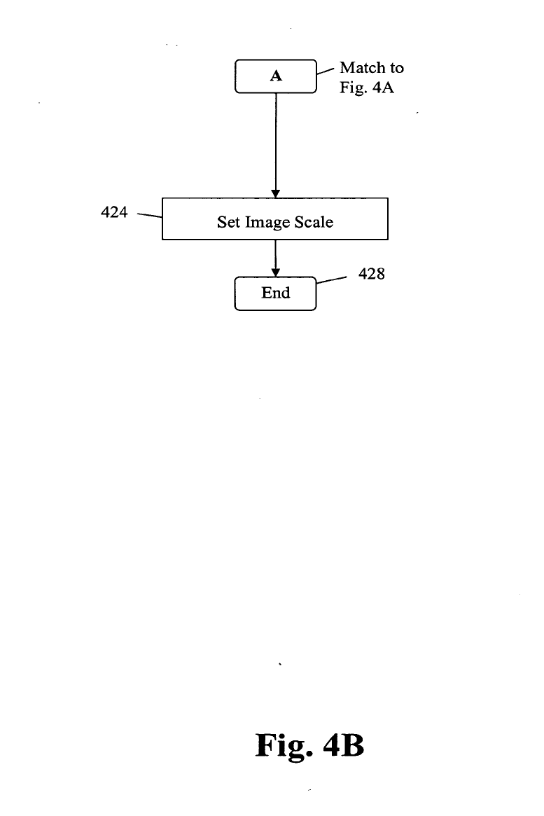

FIGS. 4A and 4B illustrate an exemplary methodology for automatically adjusting the viewing area of a circuit image displayed on a viewing device based upon selection of an object or an object feature. The blocks shown represent functions, actions or events performed therein. If embodied in software, each block may represent a module, segment or portion of code that comprises one or more executable instructions to implement the specified logical function(s). If embodied in hardware, each block may represent one or more circuits or other electronic devices to implement the specified logical function(s). It will be appreciated that computer software applications involve dynamic and flexible processes such that the functions, actions or events preformed by the software and/or the hardware can be performed in other sequences different than the one shown.

At block 406 a determination of whether the auto-scaling feature is on, or activated, is made. Determining whether the auto-scaling feature is activated is optionally accomplished by setting a bit register. Any suitable method of determining whether the auto-scaling feature is activated can be used. If the auto-scaling feature is not activated the defaults to a manual zooming mode at block 418. If auto-scaling is activated, a determination is made at block 408 of whether any scaling factors are set (e.g., have been pre-set or previously stored).

The determination of whether any scaling factors are set at block 408 can be accomplished by, for example, prompting the user or checking the scaling factors database to determine if any scaling factor values have been stored therein.

If the scaling factors are not set, at block 414 at least one scaling factor is set. Optionally, the scaling factors are set though a window that contains a list of events and allows the user to enter scaling factors for each of those events. Alternatively, the scaling factors can be set by selecting events and setting the scaling factors (e.g., “on the fly”). Still yet, the scaling factors can be set by tracking the user's preferences when the user works in a manual scaling mode. The scaling factors are optionally stored in a scaling factors database at block 414. Optionally, the user profile may also be associated with the scaling factors and stored in the scaling factors database. After the scaling factors are set at block 412 and optionally stored in the scaling factors database at block 414, an event or trigger or selection occurs at block 418.

If at block 410 it was determined that the scaling factors were set, scaling factors are obtained from any suitable source, including the scaling factors database as illustrated at, for example block 416. Optionally, the scaling factors are obtained from memory and are the last assigned scaling factors associated with each event.

The event is selected at block 418. Typical events include “selecting an object,” “selecting an object feature,” and “selecting near an object.” At block 420 a determination is made whether or not to automatically adjust the area of an image. The determination is made, for example, by identifying the scaling factor associated with the event and calculating the desired area of the circuit image to be displayed. A comparison is made between the current viewing area of the circuit image and the desired viewing area of the circuit image. If the desired viewing area is different than the current viewing area, it is determined that zooming is required and the methodology proceeds to block 424, wherein the area of the image displayed is adjusted as a function of the event and the scaling factor associated with the event. If zooming is not required, the methodology ends at block 422 and no adjustment is made to the viewing area.

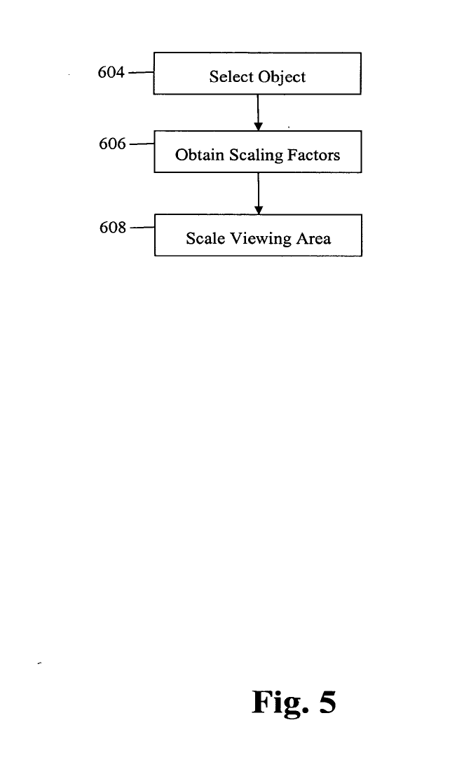

FIG. 5 illustrates an exemplary methodology for scaling a viewing area of a graphical circuit representation in a computer aided design tool.

At block 604 an object feature in the graphical circuit representation is selected. At block 606 at least one scaling factor associated with the object feature is obtained. At block 608 the viewing area of the graphical circuit representation is scaled according to the scaling factor.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, additional events, such as selection of multiple objects and different means of scaling the viewing area, such as a percentage of the entire circuit image, or limiting the percent change of the viewing area are additional modifications and considered within the spirit and scope. Therefore the invention, in its broader aspects, is not limited to the specific details, the representative system, and illustrative examples shown and described. Accordingly, departures may be made from such details without departing from the spirit or scope of the applicant's general inventive concept.

What is claimed:

1. A method for scaling a viewing area of a graphical circuit representation in a computer aided design tool comprising:
selecting an object feature in the graphical circuit representation;
obtaining at least one scaling factor associated with the object feature; and
scaling the viewing area of the graphical circuit representation according to the scaling factor.

2. The method of claim 1 further comprising displaying the object feature in the viewing area prior to selection.

3. The method of claim 1 further comprising associating at least one scaling factor with at least one object feature.

4. The method of claim 3 further comprising storing the scaling factor associated with the object feature for later retrieval.

5. The method of claim 4, wherein the obtaining step further comprises retrieving the scaling factor associated with the selected object feature.

6. The method of claim 1, wherein the selecting step further comprises inputting at least one object feature identifier.

7. The method of claim 1 wherein the adjusting step further comprises zooming the viewing area to the selected object feature as a function of the scaling factor.

8. The method of claim 7 wherein the zooming step further comprises magnifying the viewing area containing the object feature.

9. The method of claim 7 wherein the zooming step further comprises de-magnifying the viewing area containing the object feature.

10. The method of claim 1 wherein the object feature is an object.

11. A system for automatically adjusting a display area of an object in a circuit image in a viewing window comprising:
a computer aided design tool for creating the viewing window and the display view; and
auto-zoom logic for automatically adjusting the display area wherein the adjusting is a function of at least one pre-defined scaling factor.

12. The system of claim 11 further comprising a scaling factor database for storing the at least one pre-defined scaling factor associated with the object.

13. The system of claim 12 wherein the auto-zoom logic includes scaling factors logic for obtaining one or more scaling factors.

14. The system of claim 13 wherein the scaling factor logic includes logic for receiving the scaling factor from a user and associating the scaling factor with the object.

15. The system of claim 14 further including a scaling factor database for storing the scaling factor.

16. The system of claim 12 wherein the auto-zoom logic includes select event logic for inputting an event.

17. The system of claim 16 wherein the select event logic includes logic for receiving a user's selection of the object.

18. The system of claim 17 wherein the logic for receiving a user's selection includes logic for receiving a click on the object in the display area.

19. The system of claim 11 wherein the auto-zoom logic includes scale circuit image area logic for adjusting the display area based upon the object and the scaling factor.

20. The system of claim 19 wherein the scale circuit image logic includes logic for zooming to the object at a scaling factor associated with the object.

21. A computer program product for adjusting the area of a circuit image displayed on a monitor comprising:
a computer-readable medium having computer-readable program code including,
scaling factors logic for defining one or more scaling factors;
select event logic for selecting an object; and
scale circuit image area logic for adjusting the area displayed on the monitor in accordance with the scaling factor.

22. The computer program product of claim 21 further comprising a computer aided design module.

23. The computer program product of claim 22 further comprising a scaling factor database for storing the scaling factors.

24. The computer program product of claim 23 wherein the scale circuit image area logic adjusts the zoom level of the circuit image as a function of a percentage of the current circuit image zoom.

25. The computer program product of claim 22 wherein the scale circuit image area logic adjusts the zoom level of the circuit image as a function of a multiplication factor.

26. An apparatus for scaling a viewing area of a graphical circuit representation in a computer aided design tool comprising:
means for selecting an event;
means for obtaining one or more scaling factors;
means for scaling an image area as a function of the event and the one or more scaling factors.

27. The apparatus of claim 26 further comprising means for storing one or more scaling factors.

28. The apparatus of claim 26 further comprising means for associating the object with a scaling factor.

29. The apparatus of claim 26 further comprising a computer aided design module.
